(19) United States
(12) Patent Application Publication
(10) Pub. No.: US 2016/0071119 A1
(43) Pub. Date: Mar. 10, 2016

(54) SENTIMENT FEEDBACK

(71) Applicant: LONGSAND LIMITED, Cambridge (GB)

(72) Inventors: Sean Blanchflower, Cambridge (GB); Daniel Timms, Cambridge (GB)

(21) Appl. No.: 14/782,743

(22) PCT Filed: Apr. 11, 2013
(86) PCT No.: PCT/EP2013/057595

§ 371 Date: Oct. 6, 2015

(51) Int. Cl. G06Q 30/02; G06F 17/27

(52) U.S. Cl. CPC G06Q 30/0201; G06F 17/2785

(57) ABSTRACT

Techniques associated with sentiment feedback are described in various implementations. In one example implementation, a method may include generating a proposed sentiment result associated with a document, the proposed sentiment result being generated based on a rule set applied to the document. The method may also include receiving feedback about the proposed sentiment result, the feedback including an actual sentiment associated with the document and a feature of the document that is indicative of the actual sentiment. The method may also include identifying a proposed modification to the rule set based on the feedback.

### BACKGROUND

Sentiment analysis generally refers to analyzing a content source, such as a document, to determine a particular reaction or attitude being conveyed by the content source. For example, a document such as a film review on a website or a comment on a social media site may generally be considered to have a positive, negative, or neutral tone or connotation. Beyond these basic reaction types, some sentiment analysis systems may also be able to identify more complex emotional reactions, such as angry, happy, or sad.

Sentiment analysis may serve as a useful tool for organizations that wish to understand how individuals or groups regard the organization itself or the organization's offerings. For example, organizations may use sentiment analysis to actively manage and protect their respective reputations, such as by monitoring what is being written or said about them across any number of distribution channels, including, e.g., articles published in news outlets, broadcast video segments, user-generated content published on the Internet, and/or via other communications channels. As another example, organizations may use sentiment analysis for marketing purposes, e.g., to analyze and understand what a particular market segment thinks about a particular product or advertisement associated with the organization and/or its products. Sentiment analysis may also be used in a number of other useful contexts.

### BRIEF DESCRIPTION OF THE DRAWINGS

FIG. 1 is a conceptual diagram of an example sentiment analysis environment in accordance with implementations described herein.

FIG. 2 is a flow diagram of an example process for modifying a sentiment analysis ruleset based on sentiment feedback in accordance with implementations described herein.

FIG. 3 is a block diagram of an example computing system for processing sentiment feedback in accordance with implementations described herein.

FIG. 4 is a block diagram of an example system in accordance with implementations described herein.

### DETAILED DESCRIPTION

Many sentiment analysis systems utilize some form of rules-based models to analyze and determine the sentiment associated with a given document. The rulesets that are defined and applied in a given sentiment analysis system may be arbitrarily complex, ranging from relatively simplistic to extremely detailed and complicated. For example, in a very basic and simplistic system with only three rules, if a document includes the word “good” and not the word “bad”, then it is considered to have a positive tone, if a document includes the word “bad” and not the word “good”, then it is considered to have a negative tone, and otherwise, the document is considered to have a neutral tone.

More complex sentiment analysis systems may utilize significantly higher numbers of rules, significantly more complex rules, and/or may use elements from machine learning to create relatively sophisticated rulesets that are intended to cover a much broader range of scenarios. Examples of machine learning approaches that may be applied in the sentiment analysis context may include latent semantic analysis, support vector machines, “bag of words”, and other appropriate techniques.

A common characteristic of any rules-based sentiment analysis system, regardless of how basic or how complex, is that it may only be as accurate as its ruleset allows. As such, none of the sentiment analysis approaches that have been used to date have been able to achieve perfect accuracy, which may be defined as always matching what most human observers would have chosen as the “correct” or “actual” sentiment. Given the variety of types of sources that may be analyzed by sentiment analysis systems (e.g., web pages, online news sources, Internet discussion groups, online reviews, blogs, social media, and the like), it may often be the case that a particular sentiment analysis system may exhibit a high level of accuracy when analyzing a particular type of source, but may be less accurate when analyzing a different type of source. In other words, sentiment analysis systems are often tuned, either intentionally or unintentionally, to work best in a given context.

Described herein are techniques for improving the accuracy of rules-based sentiment analysis systems by providing for more useful and detailed feedback about the sentiment results that are being generated by the respective systems. Rather than simply providing the “correct” sentiment result in a given situation, the system allows for feedback that indicates the “correct” sentiment of the document as well as the feature (or features) of the document that is (or are) indicative of the actual sentiment. Based on the more detailed feedback, the ruleset of the sentiment analysis system may be updated in a more targeted manner. The techniques described herein may be used in conjunction with sentiment analysis systems having relatively simplistic or relatively complex rulesets to improve the accuracy of those systems. These and other possible benefits and advantages will be apparent from the figures and from the description that follows.

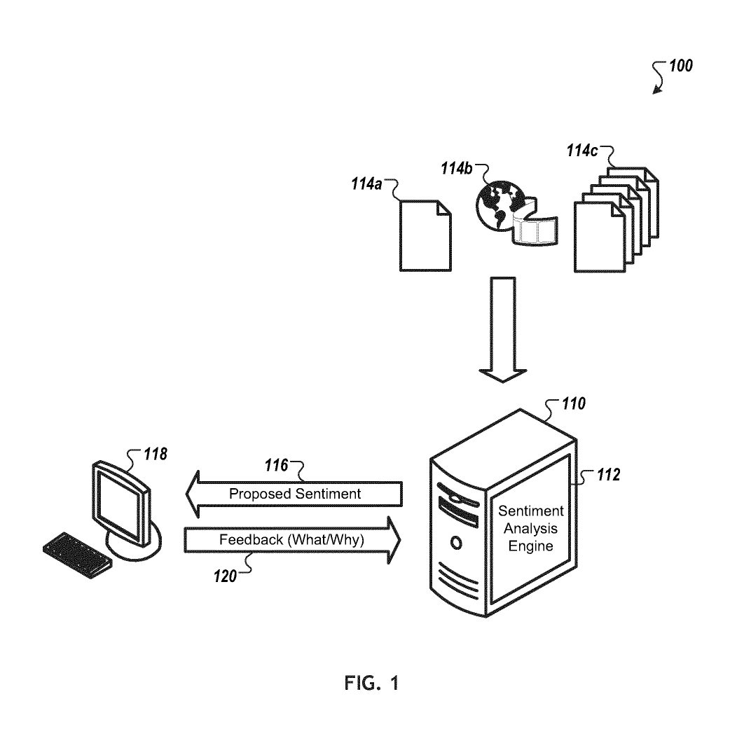

FIG. 1 is a conceptual diagram of an example sentiment analysis environment 100 in accordance with implementations described herein. As shown, environment 100 includes a computing system 110 that is configured to execute a sentiment analysis engine 112. The example topology of environment 100 may be representative of various sentiment analysis environments. However, it should be understood that the example topology of environment 100 is shown for illustrative purposes only, and that various modifications may be made to the configuration. For example, environment 100 may include different or additional components, or the components may be implemented in a different manner than is shown. Also, while computing system 110 is generally illustrated as a standalone server, it should be understood that computing system 110 may, in practice, be any appropriate type of computing device, such as a server, a blade server, a mainframe, a laptop, a desktop, a workstation, or other device. Computing system 110 may also represent a group of computing devices, such as a server farm, a server cluster, or other group of computing devices operating individually or together to perform the functionality described herein.

During runtime, the sentiment analysis engine 112 may be used to analyze any appropriate type of document, and to generate a sentiment result that indicates the sentiment or tone of the document, or of a specific portion of the document. Depending upon the configuration of sentiment analysis engine 112, the engine may be able to perform sentiment analysis, for example, on text-based documents 114a, audio, video, or multimedia documents 114b, and/or sets of documents 114c. In the case of audio, video, or multimedia documents 114b, the sentiment analysis engine 112 may be configured to analyze the documents natively, or may include a “to text” converter (e.g., a speech-to-text transcription module or an image-to-text module) that converts the audio, video, or multimedia portion of the document into text for a text-based sentiment analysis. The sentiment analysis engine 112 may also be configured to perform sentiment analysis on other appropriate types of documents, either with or without “to text” conversion.

The sentiment result generated by the sentiment analysis engine 112 may generally include the sentiment (e.g., positive, negative, neutral, or the like) associated with the document or with a specific portion of the document. The sentiment result may also include other information. For example, the sentiment result may include one or more particular rules that were implicated in generating the sentiment associated with the document. Such implicated rules, which may also be referred to as triggered rules, may help to explain why a particular sentiment was identified for a particular document. As another example, the sentiment result may include the specific portion of the document to which the sentiment applies. As another example, the sentiment result may include multiple sentiments associated with different portions of a document, and may also include the respective portions of the document to which each of the respective sentiments apply.

The sentiment result may be used in different ways, depending on the implementation. For example, in some cases, the sentiment result may be used to tag the document (e.g., by using a metadata tagging module) after it has been analyzed, such that the metadata of the document itself contains the sentiment or sentiments associated with the document. In other cases, the sentiment result or portions thereof may simply be returned to a user. For example, the user may provide a document to the sentiment analysis engine 112, and the sentiment result may be returned to the user, e.g., via a user interface such as a display. Other appropriate runtime uses for the sentiment result may also be implemented.

The runtime scenarios described above generally operate by the sentiment analysis engine 112 applying a pre-existing ruleset to an input document to generate a sentiment result, without regard for whether the sentiment result is accurate or not. The remainder of this description generally relates to sentiment analysis training scenarios using the sentiment feedback techniques described herein to improve the accuracy of the sentiment analysis system. However, in some cases, all or portions of the sentiment analysis training scenarios may also be implemented during runtime to continuously fine-tune the system's ruleset. For example, end users of the sentiment analysis system may provide information similar to that of users who are explicitly involved in training the system (as described below), and such end user provided information may be used to improve the accuracy of sentiment analysis in a similar manner as such improvements that are based on trainer feedback. In various implementations, end user feedback may be provided either explicitly (e.g., in a manner similar to trainer feedback), implicitly (e.g., by analyzing end user behaviors associated with the sentiment result, such as click-through or other indirect behaviors), or some combination.

During explicit system training scenarios, the sentiment analysis engine 112 may operate similarly to the runtime scenarios described above. For example, sentiment analysis engine 112 may analyze an input document, and may generate a sentiment result that indicates the sentiment or tone of the document, or of a specific portion of the document. However, rather than being an absolute sentiment that is representative of the system's view of a particular document, the sentiment result in the training scenario may be considered a proposed sentiment result. A proposed sentiment result that matches the trainer's determination of sentiment may be used to reinforce certain rules as being applicable to different use cases, while a proposed sentiment result that does not match the trainer's determination of sentiment may indicate that the ruleset is incomplete, or that certain rules may be defined incorrectly (e.g., as over-inclusive, under-inclusive, or both).

The proposed sentiment result may generally include the sentiment (e.g., positive, negative, or neutral) associated with the document or with a specific portion of the document. The proposed sentiment result may also include other information. For example, the proposed sentiment result may include one or more particular rules (e.g., triggered rules) that were implicated in generating the sentiment associated with the document. As another example, the proposed sentiment result may include the specific portion of the document to which the sentiment applies. As another example, the proposed sentiment result may include multiple proposed sentiments associated with different portions of a document, and the respective portions of the document to which those proposed sentiments apply. As another example, the proposed sentiment result may include specific dictionary words that were identified while determining the sentiment. As another example, the proposed sentiment result may include a specific topic that was identified as being discussed with a particular sentiment. It should be understood that the sentiment result may include any appropriate combination of these or other types of information.

The proposed sentiment result may be provided (e.g., as shown by arrow 116) to a trainer, such as a system administrator or other appropriate user. For example, the sentiment result may be displayed on a user interface of a computing device 118. The trainer may then provide feedback back to the sentiment analysis engine 112 (e.g., as shown by arrow 120) about the proposed sentiment result. The feedback may be provided, for example, via the user interface of computing device 118.

The feedback about the proposed sentiment result may include the actual sentiment associated with the document as well as the feature (or features) of the document that is (or are) indicative of the actual sentiment. For example, the trainer may identify the correct sentiment of the document and the particular feature that is most indicative of the correct sentiment, and may provide such feedback to the sentiment analysis engine 112. Based on the more detailed feedback that includes the “what” and the “why” associated with the actual sentiment (rather than just identifying what the actual sentiment is), the sentiment analysis engine 112 may update its ruleset in a more targeted manner.

For example, in the case of a fifteen page journal article describing a positive outcome to an experiment, the abstract of the article may include a number of generally positive terms such as “good” or “improved” or “positive”, but the body of the article may include several more occurrences of the terms “incorrect” or “bad” or “failed”, e.g., to identify previous approaches and why those previous approaches were unsuccessful. Assuming a basic sentiment analysis ruleset that identifies particular words as positive or negative, and that also includes a rule that simply counts the occurrences of positive versus negative terms and assigns a sentiment based on whichever count is higher, the article described above may be considered negative in tone by the system, even though the trainer reading the article would consider the tone to be positive. In this case, the actual sentiment (determined by the trainer to be positive) would be different from the proposed sentiment (determined by the system to be negative).

In such a case, simply feeding back that the system got it wrong, e.g., that the actual sentiment should be positive rather than negative, may prove to be somewhat useful to the system (which may then update its sentiment result for that particular document), but may not be as useful to the system in terms of identifying an updated rule (or rules) that would more accurately predict the sentiment of other similar documents. As such, in accordance with the techniques described here, the trainer may also identify the feature of the document that is indicative of the actual positive sentiment (e.g., the text of the abstract as opposed to the text of the entire article), and the sentiment analysis ruleset may be updated in a more targeted manner, e.g., by giving greater weight to the terms in the abstract as opposed to terms in other portions of the article, or by otherwise adjusting the ruleset so that an accurate result is achieved. In some cases, different modifications to the ruleset may be proposed and/or tested to determine the most comprehensive or best fit adjustments to the system.

Other updates to the sentiment analysis ruleset may similarly be based on where particular terms or phrases are located within a particular document (e.g., terms located in the title, abstract, summary, conclusion, or other appropriate sections may be considered more important or at least more indicative of sentiment, and therefore given greater weight). Similarly, other rules may be updated based on feedback about the content (e.g., text) of the document itself. For example, the trainer may identify a particular phrase or other textual usage that was mishandled by a rule in the ruleset, and may point to that text in the document as being indicative of the actual sentiment of the document. Continuing with the example, the document may include the phrase “not good”, which a naïve system may view as positive because it includes the term “good”, and the trainer may indicate that the modified usage of “not good” is contraindicative of a positive sentiment.

The text-based examples described above are relatively simplistic and are used to illustrate the basic operation of the sentiment feedback system, but it should be understood that the feedback mechanism may also be used in more complex scenarios. For example, the feedback mechanism may allow the trainer to identify more complex language patterns or contexts, such as by identifying various linguistic aspects, including prefixes, suffixes, keywords, phrasal usage, sarcasm, irony, and/or parody. By identifying specific instances of such language patterns and/or contexts, the sentiment analysis system may be trained to identify similar patterns and/or contexts, and to analyze them accordingly, e.g., by implementing additional or modified rules in the ruleset.

In addition to text-based features present in the content of the document, the trainer may also provide feedback that identifies a classification associated with the document as another feature that is indicative of actual sentiment. The classification associated with a document may include any appropriate classifier, such as the conceptual topic of the document, the type of content being examined, and/or the document context, as well as other classifiers that may be associated with the document, such as author, language, publication date, source, or the like. These classifiers may be indicative of the actual sentiment of the document, e.g., by providing a context in which to apply the linguistic rules associated with the text and/or other content of the document.

In some cases, a particular term or phrase may have multiple meanings (sometimes even opposite meanings), depending on the context in which the term or phrase is used. For example, a document about a well-executed bathroom renovation written in German might include multiple instances of the word “bad”, which translates to “bath” in English. If the context (i.e., source language) of the document was not understood to be German, then the system would likely attribute a negative tone to the document based on the multiple instances of the word “bad”, even though the document actually included glowing praise of the bathroom renovation. As such, the system may be improved by implementing a rule that does not ascribe a negative connotation to “bad” if that word is used in a German-language document.

As another example, the word “hysterical” may be considered very positive (e.g., in a review of a sitcom or a comedian) or may be considered very negative (e.g., in describing a person's behavior) depending on the context. As such, the system may be improved by implementing a rule that evaluates the positive or negative connotation of the word “hysterical” based on the conceptual topic of the document in general.

In some implementations, the trainer may provide feedback that includes both a selected portion of the document as well as a classification associated with the document, both of which or a combination of which are indicative of the actual sentiment of the document. Based upon such feedback, the sentiment analysis system may be updated to identify similar phrasal usages in a particular context, and to determine the correct sentiment accordingly, e.g., by implementing additional or modified rules in the ruleset.

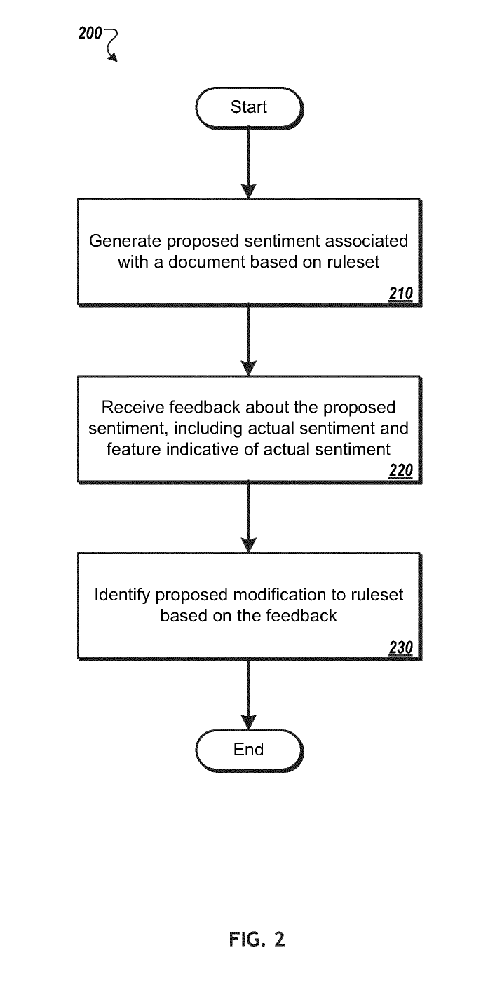

FIG. 2 is a flow diagram of an example process 200 for modifying a sentiment analysis ruleset based on sentiment feedback in accordance with implementations described herein. The process 200 may be performed, for example, by a sentiment analysis engine such as the sentiment analysis engine 112 illustrated in FIG. 1. For clarity of presentation, the description that follows uses the sentiment analysis engine 112 illustrated in FIG. 1 as the basis of an example for describing the process. However, it should be understood that another system, or combination of systems, may be used to perform the process or various portions of the process.

Process 200 begins at block 210, in which a proposed sentiment result associated with a document is generated based on a ruleset applied to the document. For example, sentiment analysis engine 112 may generate the proposed sentiment for a particular document based on a ruleset implemented by the engine.

In some cases, sentiment analysis engine 112 may also identify one or more triggered rules from the ruleset that affect the proposed sentiment result, and may cause the triggered rules to be displayed to a user. Continuing with the journal article example described above, the triggered rules may include rules that define the terms “good”, “improved”, and “positive” as being indicative of a positive sentiment, rules that define the terms “incorrect”, “bad”, and “failed” as being indicative of a negative sentiment, and a general rule that determines sentiment based on the greater count of either positive-related or negative-related terms. Each of these rules would have been triggered in generating the overall proposed sentiment result, so each of the rules may be displayed to the user. Such information may assist the user in understanding why a particular sentiment result was generated. In some cases, the number of triggered rules may be quite numerous, and so the sentiment analysis engine 112 may instead only display higher-order rules that were triggered in generating the proposed sentiment result. For example, in the example above, the system may only display the “greater count” rule to the user. In some implementations, the user may also be allowed to drill down into the higher-order rules to see additional lower-order rules that also affected the proposed sentiment result as necessary.

At block 220, feedback about the proposed sentiment result is received. The feedback may include an actual sentiment associated with the document and a feature of the document that is indicative of the actual sentiment. For example, sentiment analysis engine 112 may receive (e.g., from a trainer or from another appropriate user) feedback that identifies the actual sentiment of the document as well as the feature of the document that is most indicative of the actual sentiment. In some implementations, the feature of the document that is indicative of the actual sentiment may include a portion of content from the document (e.g., a selection from the document that is most indicative of the actual sentiment). In some implementations, the feature of the document that is indicative of the actual sentiment may include a classification associated with the document (e.g., a conceptual topic or language associated with the document). In some implementations, the feedback may include both a selected portion of the document as well as a classification associated with the document, both of which or a combination of which are indicative of the actual sentiment of the document.

At block 230, a proposed modification to the ruleset is identified based on the received feedback. For example, sentiment analysis engine 112 may identify a new rule or a change to an existing rule in the ruleset based on the feedback identifying the features of the document that are most indicative of the actual sentiment of the document.

In the case of a change to an existing rule, sentiment analysis engine 112 may determine, based on the feedback, that one or more existing rules that were triggered during the generation of the proposed sentiment result were defined incorrectly (e.g., under-inclusive, over-inclusive, or both) if the proposed sentiment result does not match the actual sentiment. In such a case, the sentiment analysis engine 112 may generate a proposed modification to one or more of the triggered rules based on the feature identified in the feedback. In some cases, the triggered rule and the proposed change to the triggered rule may be displayed to the user.

By way of a simple example, if an existing rule of the ruleset states that all documents including the word “terrible” are to be considered as having a negative sentiment, the rule may be identified as over-inclusive when the trainer determines that a document describing a child's incredible development during the “terrible twos” is actually positive in tone. In response to this use case which tends to disprove the more general rule, the sentiment analysis engine 112 may identify one or more proposed modifications to the “terrible” rule, such as by deprecating the negative connotation when used in specific contexts, by identifying specific exceptions to the general rule, or by other possible modifications.

In the case of a new rule, sentiment analysis engine 112 may determine, based on the feedback, that the feature of the document identified as being indicative of the actual sentiment was not used when generating the proposed sentiment result, which may indicate that the ruleset does not include an appropriate rule to capture the specific scenario present in the document being analyzed. In such a case, the sentiment analysis engine 112 may generate a new proposed rule to be added to the ruleset based on the feature identified in the feedback.

In some cases, sentiment analysis engine 112 may also cause the proposed modification to the ruleset (either a new rule or a change to an existing rule) to be displayed to a user, and may require verification from the user that such a proposed modification to the ruleset is acceptable. For example, the sentiment analysis engine 112 may cause the proposed modification to be displayed to the trainer who provided the feedback, and may only apply the proposed change to the ruleset in response to receiving a confirmation of the proposed change by the user.

In some implementations, sentiment analysis engine 112 may also identify other known documents (e.g., from a corpus of previously-analyzed documents) that would have been analyzed similarly or differently based on the proposed modification to the ruleset. In such implementations, a notification may be displayed to the user indicating the documents that would have been analyzed similarly or differently, e.g., so that the user can understand the potential ramifications of applying such a modification. By identifying documents that might be affected by the proposed modification to the ruleset, the system may help prevent the situation where new sentiment analysis problems are created when others are fixed.

In some cases, different modifications to the ruleset may be proposed and/or tested to determine the most comprehensive or best fit adjustments to the system. For example, sentiment analysis engine 112 may identify multiple possible modifications to the ruleset, each of which would reach the “correct” sentiment result and which would also satisfy the constraints of the feedback. In such cases, the sentiment analysis engine 112 may discard as a possible modification any modification that would adversely affect the “correct” sentiment of a previously analyzed document.

FIG. 3 is a block diagram of an example computing system 300 for processing sentiment feedback in accordance with implementations described herein. Computing system 300 may, in some implementations, be used to perform certain portions or all of the functionality described above with respect to computing system 110 of FIG. 1, and/or to perform certain portions or all of process 200 illustrated in FIG. 2.

Computing system 300 may include a processor 310, a memory 320, an interface 330, a sentiment analyzer 340, a rule updater 350, and an analysis rules and data repository 360. It should be understood that the components shown here are for illustrative purposes only, and that in some cases, the functionality being described with respect to a particular component may be performed by one or more different or additional components. Similarly, it should be understood that portions or all of the functionality may be combined into fewer components than are shown.

Processor 310 may be configured to process instructions for execution by computing system 300. The instructions may be stored on a non-transitory, tangible computer-readable storage medium, such as in memory 320 or on a separate storage device (not shown), or on any other type of volatile or non-volatile memory that stores instructions to cause a programmable processor to perform the techniques described herein. Alternatively or additionally, computing system 300 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 330 may be implemented in hardware and/or software, and may be configured, for example, to provide sentiment results and to receive and respond to feedback provided by one or more users. For example, interface 330 may be configured to receive or locate a document or set of documents to be analyzed, to provide a proposed sentiment result (or set of sentiment results) to a trainer, and to receive and respond to feedback provided by the trainer. Interface 330 may also include one or more user interfaces that allow a user (e.g., a trainer or system administrator) to interact directly with the computing system 300, e.g., to manually define or modify rules in a ruleset, which may be stored in the analysis rules and data repository 360. Example user interfaces may include touchscreen devices, pointing devices, keyboards, voice input interfaces, visual input interfaces, or the like.

Sentiment analyzer 340 may execute on one or more processors, e.g., processor 310, and may analyze a document using the ruleset stored in the analysis rules and data repository 360 to determine a proposed sentiment result associated with the document. For example, the sentiment analyzer 340 may parse a document to determine the terms and phrases included in the document, the structure of the document, and other relevant information associated with the document. Sentiment analyzer 340 may then apply any applicable rules from the sentiment analysis ruleset to the parsed document to determine the proposed sentiment result. After determining the proposed sentiment result using sentiment analyzer 340, the proposed sentiment may be provided to a user for review and feedback, e.g., via interface 330.

Rule updater 350 may execute on one or more processors, e.g., processor 310, and may receive feedback about the proposed sentiment result. The feedback may include an actual sentiment associated with the document, e.g., as determined by a user. The feedback may also include a feature of the document that is indicative (e.g., most indicative) of the actual sentiment. For example, the user may identify a particular feature (e.g., a particular phrasal or other linguistic usage, a particularly relevant section of the document, or a particular classification of the document), or some combination of features, that supports the user's assessment of actual sentiment.

In response to receiving the feedback, rule updater 350 may generate a proposed modification to the ruleset based on the feedback as described above. For example, rule updater 350 may suggest adding one or more new rules to cover a use case that had not previously been defined in the ruleset, or may suggest modifying one or more existing rules in the ruleset to correct or improve upon the existing rules.

Analysis rules and data repository 360 may be configured to store the sentiment analysis ruleset that is used by sentiment analyzer 340. In addition to the ruleset, the repository 360 may also store other data, such as information about previously analyzed documents and their corresponding “correct” sentiments. By storing such information about previously analyzed documents, the computing system 300 may ensure that proposed modifications to the ruleset do not impinge upon previously analyzed documents. For example, rule updater 350 may generate multiple proposed modifications to the ruleset that may fix an incorrect sentiment result, some of which would implement broader changes to the ruleset than others. If rule updater 350 determines that one of the proposed modifications would adversely affect the “correct” sentiment of a previously analyzed document, updater 350 may discard that proposed modification as a possibility, and may instead only propose modifications that are narrower in scope, and that would not adversely affect the proposed sentiment of a previously analyzed document.

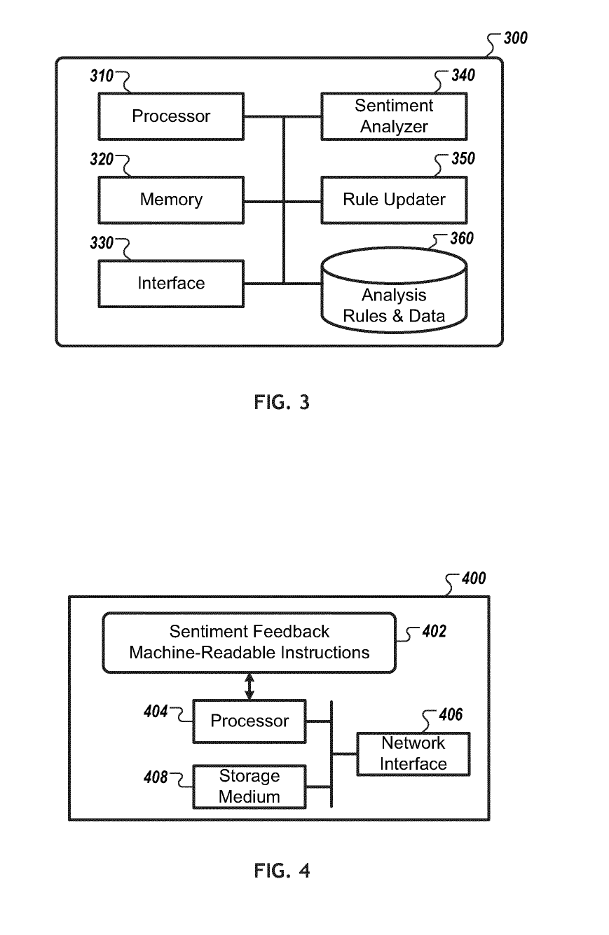

FIG. 4 shows a block diagram of an example system 400 in accordance with implementations described herein. The system 400 includes sentiment feedback machine-readable instructions 402, which may include certain of the various modules of the computing devices depicted in FIGS. 1 and 3. The sentiment feedback machine-readable instructions 402 may be loaded for execution on a processor or processors 404. As used herein, a processor may include a microprocessor, microcontroller, processor module or subsystem, programmable integrated circuit, programmable gate array, or another control or computing device. The processor(s) 404 may be coupled to a network interface 406 (to allow the system 400 to perform communications over a data network) and/or to a storage medium (or storage media) 408.

The storage medium 408 may be implemented as one or multiple computer-readable or machine-readable storage media. The storage media may include different forms of memory including semiconductor memory devices such as dynamic or static random access memories (DRAMs or SRAMs), erasable and programmable read-only memories (EPROMs), electrically erasable and programmable read-only memories (EEPROMs), and flash memories; magnetic disks such as fixed, floppy and removable disks; other magnetic media including tape; optical media such as compact disks (CDs) or digital video disks (DVDs); or other appropriate types of storage devices.

Note that the instructions discussed above may be provided on one computer-readable or machine-readable storage medium, or alternatively, may be provided on multiple computer-readable or machine-readable storage media distributed in a system having plural nodes. Such computer-readable or machine-readable storage medium or media is (are) considered to be part of an article (or article of manufacture). An article or article of manufacture may refer to any appropriate manufactured component or multiple components. The storage medium or media may be located either in the machine running the machine-readable instructions, or located at a remote site, e.g., from which the machine-readable instructions may be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A computer-implemented method of processing sentiment feedback, the method comprising:
generating, with a computing system, a proposed sentiment result associated with a document, the proposed sentiment result being generated based on a ruleset applied to the document;
receiving, with the computing system, feedback about the proposed sentiment result, the feedback including an actual sentiment associated with the document and a feature of the document that is indicative of the actual sentiment; and
identifying, with the computing system, a proposed modification to the ruleset based on the feedback.

2. The computer-implemented method of claim 1, further comprising causing the proposed modification to the ruleset to be displayed to a user, and applying the proposed modification to the ruleset in response to receiving a confirmation by the user.

3. The computer-implemented method of claim 1, wherein the feature of the document that is indicative of the actual sentiment comprises a portion of content from the document.

4. The computer-implemented method of claim 1, wherein the feature of the document that is indicative of the actual sentiment comprises a classification associated with the document.

5. The computer-implemented method of claim 1, wherein identifying the proposed modification to the ruleset comprises identifying a triggered rule from the ruleset that affects the proposed sentiment result, and generating a proposed change to the triggered rule when the proposed sentiment result does not match the actual sentiment, the proposed change to the triggered rule being generated based on the feature of the document that is indicative of the actual sentiment.

6. The computer-implemented method of claim 5, further comprising causing the triggered rule and the proposed change to the triggered rule to be displayed to a user.

7. The computer-implemented method of claim 1, wherein identifying the proposed modification to the ruleset comprises generating a new proposed rule to be added to the ruleset, the new proposed rule being based on the feature of the document that is indicative of the actual sentiment.

8. The computer-implemented method of claim 1, further comprising identifying a triggered rule from the ruleset that affects the proposed sentiment result, and causing the triggered rule to be displayed to a user.

9. The computer-implemented method of claim 1, further comprising identifying other documents, from a corpus of previously-analyzed documents, that would be affected by the proposed modification to the ruleset, and causing a notification to be displayed to a user, the notification indicating the other documents.

10. A sentiment analysis feedback system comprising:
one or more processors;
a sentiment analyzer, executing on at least one of the one or more processors, that analyzes a document using a ruleset to determine a proposed sentiment result associated with the document; and
a rule updater, executing on at least one of the one or more processors, that receives feedback about the proposed sentiment result, the feedback including an actual sentiment associated with the document and a feature of the document that is indicative of the actual sentiment, and generates a proposed modification to the ruleset based on the feedback.

11. The sentiment analysis feedback system of claim 10, wherein the rule updater causes the proposed modification to the ruleset to be displayed to a user, and updates the ruleset with the proposed modification in response to receiving a confirmation by the user.

12. The sentiment analysis feedback system of claim 10, wherein the rule updater generates the proposed modification to the ruleset by identifying a triggered rule from the ruleset that affects the proposed sentiment result, and generating a proposed update to the triggered rule when the proposed sentiment result does not match the actual sentiment, the proposed update to the triggered rule being generated based on the feature of the document that is indicative of the actual sentiment.

13. The sentiment analysis feedback system of claim 12, wherein the rule updater causes the triggered rule and the proposed update to the triggered rule to be displayed to a user.

14. The sentiment analysis feedback system of claim 10, wherein the rule updater generates the proposed modification to the ruleset by generating a new proposed rule to be added to the ruleset, the new proposed rule being based on the feature of the document that is indicative of the actual sentiment.

15. A non-transitory computer-readable storage medium storing instructions that, when executed by one or more processors, cause the one or more processors to:
generate a proposed sentiment result associated with a document, the proposed sentiment result being generated based on a ruleset applied to the document;
receive feedback about the proposed sentiment result, the feedback including an actual sentiment associated with the document and a classification associated with the document; and
identify a proposed modification to the ruleset based on the feedback.
